(19) United States
(12) Patent Application Publication
(10) Pub. No.: US 2020/0169044 A1
(43) Pub. Date: May 28, 2020

(54) SFP-DD FOOLPROOF KEY IMPROVEMENT AND IDEA

(71) Applicant: Molex, LLC, Lisle, IL (US)

(72) Inventors: Wei Che SUN, New Taipei City (TW); Yen-Lin CHEN, New Taipei City (TW)

(73) Assignee: Molex, LLC, Lisle, IL (US)

(21) Appl. No.: 16/659,588

(22) Filed: Oct. 22, 2019

(30) Foreign Application Priority Data
Oct. 22, 2018 (CN) 201821714384.3

(51) Int. Cl. H01R 13/6581; H01R 13/64

(52) U.S. Cl. CPC H01R 13/6581; H01R 13/64

(57) ABSTRACT

An electrical connection device comprises a shield cage assembly and an electrical connector. The shield cage assembly comprises a metal cage and a ground member. The metal cage defines a port and an accommodating space extending from the port along a mating direction, and the metal cage has a keyway which extends from the port along the mating direction. The ground member is provided to an outer surface of the metal cage adjacent to the port, and the ground member has a main body which is connected with the metal cage, a bending portion which bends back from an edge of the main body, extends and is adjacent to the port, and a plurality of elastic fingers which extend from the bending portion, the main body has a guiding cover portion which bulges, the guiding cover portion correspondingly covers the keyway and defines a passage which is communicated with the keyway. The electrical connector is positioned in the accommodating space. The guiding cover portion of the ground member at the port has a double-layer metal sheet thickness by the bending portion, is relatively strong in structure.

### TECHNICAL FIELD

The present disclosure relates to a shield cage assembly, and particularly relates to a shield cage assembly which is used to shield an electrical connector and an electrical connection device which has the shield cage assembly.

### BACKGROUND

Some electrical connection devices with metal cages are provided with a keyway extending outwardly from a port at a metal cage for fool proofing, so as to allow a mating connector having a key corresponding to the keyway to mate therewith. For example Chinese patent application publication No. CN1929342A (corresponding to United States patent application publication No. US2007054551) discloses an optical transceiver and cage system, a slot provided on the cage thereof is equivalent to the keyway and a tab of the transceiver module thereof is equivalent to the key. Design patent No. DM101671, which is registered with the World Intellectual Property Organization (WIPO), discloses a receptacle connector, which is provided with a ground piece at an outer circumference of the cage thereof adjacent to the port, and the ground piece forms a bulged structure corresponding to the keyway of the cage to form a passage. The ground piece is generally made of a metal sheet having a thickness of 0.1 mm, however, the strength of the budged structure of the single-layer metal sheet is relatively insufficient, so that when the cage is assembled to a panel with the port facing forwardly, the budged structure at the port is easy to deform due to accidental collision with the panel, which in turn affects the mating of the receptacle connector with the mating connector.

### SUMMARY

Therefore, one of objects of the present disclosure is to provide a shield cage assembly which can solve the aforementioned problem.

Accordingly, in some embodiments, a shield cage assembly of the present disclosure comprises a metal cage and a ground member. The metal cage defines a port and an accommodating space extending from the port along a mating direction, and the metal cage has a keyway which extends from the port along the mating direction. The ground member is provided to an outer surface of the metal cage adjacent to the port, and the ground member has a main body which is connected with the metal cage, a bending portion which bends back from an edge of the main body, extends and is adjacent to the port, and a plurality of elastic fingers which extend from the bending portion, the main body has a guiding cover portion which bulges, the guiding cover portion correspondingly covers the keyway and defines a passage which is communicated with the keyway.

In some embodiments, the plurality of elastic fingers extend from the bending portion away from the port.

In some embodiments, at least one of the elastic fingers is positioned at an outer surface of the guiding cover portion.

In some embodiments, the main body further has a rear cover portion which connects the guiding cover portion and covers an end of the passage opposite to the port.

In some embodiments, the rear cover portion has a cover segment which covers the passage and a bottom contact segment which bends from the cover segment, extends and contacts the metal cage.

In some embodiments, the rear cover portion further has at least one side contact segment which bends from the cover segment, extends and contacts the guiding cover portion.

In some embodiments, the metal cage has at least one positioning portion protruding outwardly, the main body further has at least one positioning hole correspondingly receiving the at least one positioning portion.

Another object of the present disclosure is to provide an electrical connection device which comprises the aforementioned shield cage assembly.

Thus, in some embodiments, an electrical connection device of the present disclosure comprises the aforementioned shield cage assembly and an electrical connector which is positioned in the accommodating space and comprises a slot, the slot extends toward the port along the mating direction.

The present disclosure has the following technical effects: the ground member may be formed by stamping and bending a metal sheet, which is easy to manufacture, and the guiding cover portion of the ground member at the port has a double-layer metal sheet thickness by the bending portion, is relatively strong in structure and is not easily deformed by collision.

### BRIEF DESCRIPTION OF THE DRAWINGS

Other features and effects of the present disclosure will be apparent from the embodiments with reference to figures, in which:

FIG. 1 is a perspective view of a first embodiment of an electrical connection device of the present disclosure;

FIG. 2 is a perspective view of the first embodiment viewed from another angle;

FIG. 3 is a perspective view of the first embodiment viewed from another angle;

FIG. 4 is a perspective exploded view of the first embodiment;

FIG. 5 is an enlarged view of a part of FIG. 4;

FIG. 6 is a front view of the first embodiment;

FIG. 7 is a cross sectional view taken along a line VII-VII of FIG. 6;

FIG. 8 is a perspective view of a second embodiment of the electrical connection device of the present disclosure;

FIG. 9 is a perspective view of the second embodiment viewed from another angle;

FIG. 10 is an enlarged view of a partial area of FIG. 9; and

FIG. 11 is a top view of the ground member of the second embodiment.

Reference numerals in figures are represented as follows:
1 shield cage assembly
2 electrical connector
   21 slot
3 metal cage
   31 top wall
   32 bottom wall
   33 side wall
   34 port
   35 accommodating space
   36 keyway
   37 positioning portion
4 ground member
   4A upper member
   4B lower member
   41 main body
      411 guiding cover portion
         411a passage
      412 rear cover portion
         412a cover segment
         412b bottom contact segment
         412c side contact segment
      42 bending portion
      43 elastic finger
      44 positioning hole
D mating direction

### DETAILED DESCRIPTION OF PREFERRED EMBODIMENTS

Before the present disclosure is described in detail, it should be noted that similar element is represented by the same reference numeral in the following description.

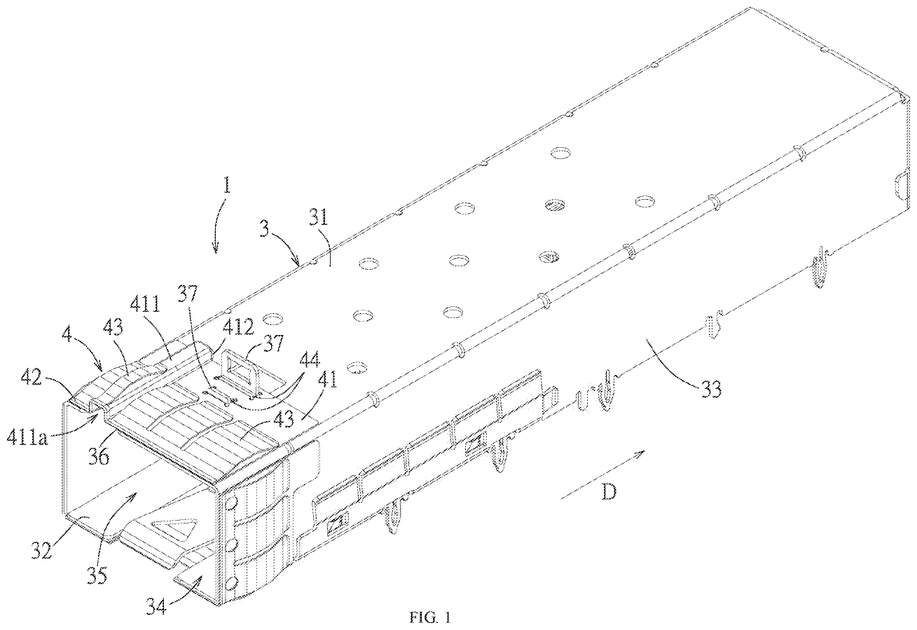

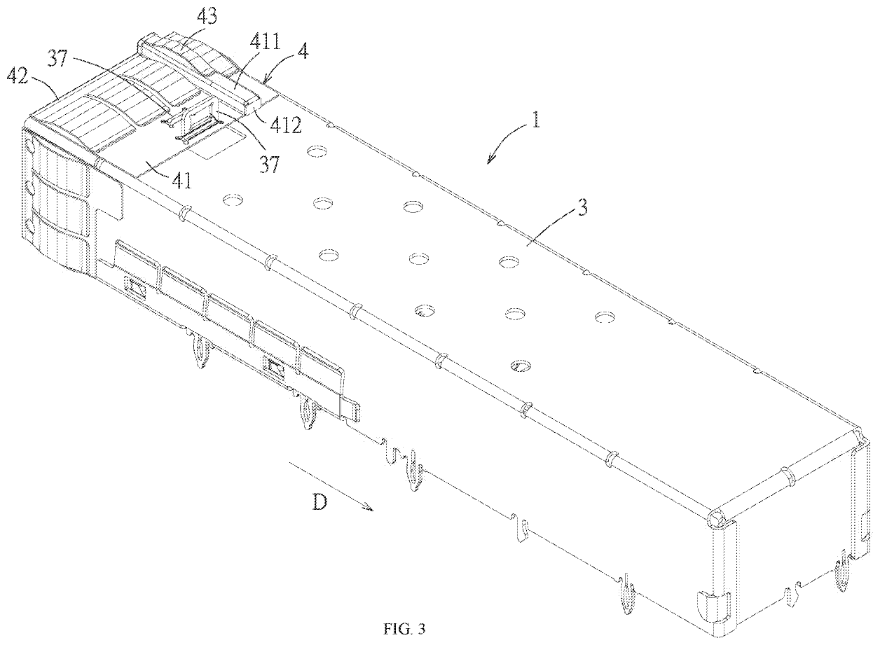

Referring to FIG. 1 to FIG. 3, a first embodiment of an electrical connection device of the present disclosure comprises a shield cage assembly 1 and an electrical connector 2.

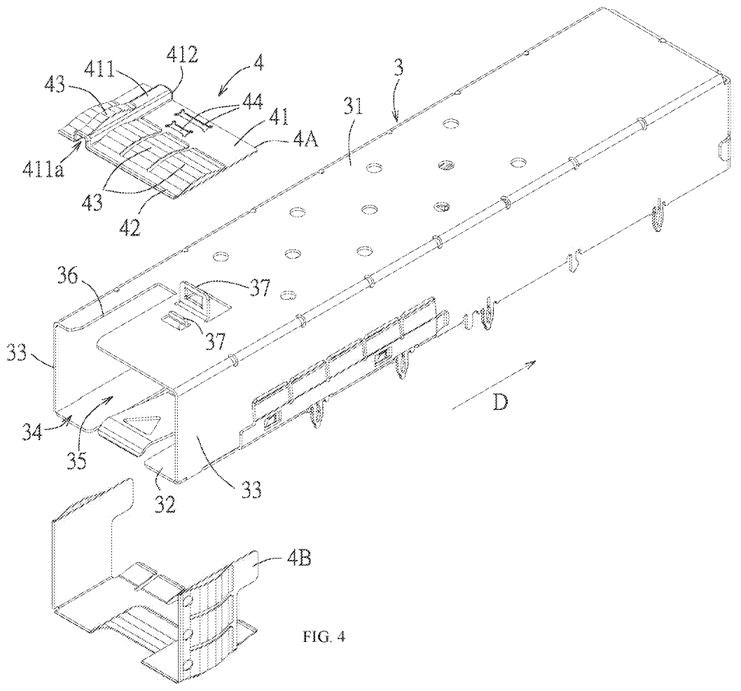

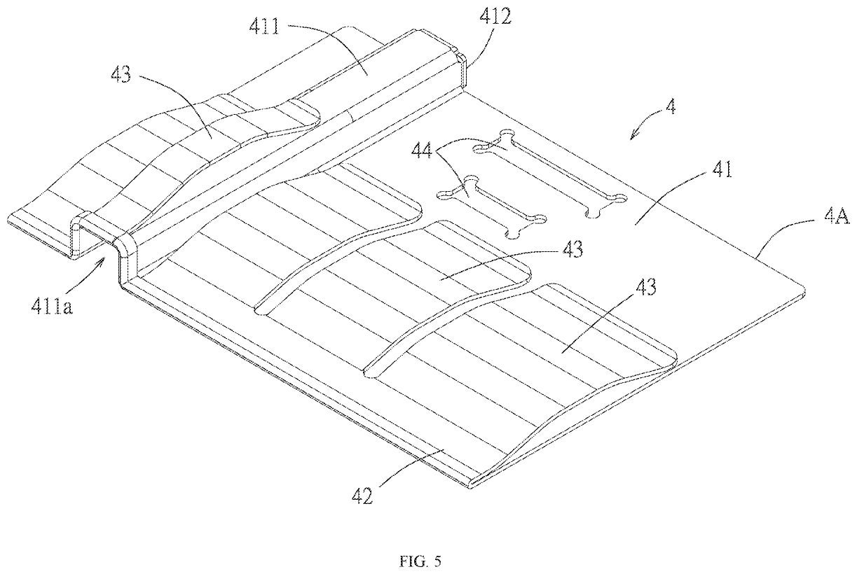

Referring to FIG. 4 and FIG. 5, the shield cage assembly 1 comprises a metal cage 3 and a ground member 4. The metal cage 3 has a top wall 31, a bottom wall 32 and two side walls 33 to define a port 34 and an accommodating space 35 extending from the port 34 along a mating direction D, and the metal cage 3 has a keyway 36 which extends from the port 34 along the mating direction D. In the embodiment, the keyway 36 is formed on the top wall 31, but the keyway 36 may also be formed on the side wall 33 in a varied embodiment. The ground member 4 is provided to an outer surface of the metal cage 3 adjacent to the port 34, and the ground member 4 has a main body 41 which is connected with the metal cage 3, a bending portion 42 which bends back from an edge of the main body 41, extends and is adjacent to the port 34, and a plurality of elastic fingers 43 which extend from the bending portion 42. The main body 41 has a guiding cover portion 411 which bulges, the guiding cover portion 411 correspondingly covers the keyway 36 and defines a passage 411a which is communicated with the keyway 36 to receive a key of a mating electrical connection device (not shown) for fool proofing. The main body 41 further has a rear cover portion 412 which connects the guiding cover portion 411 and covers an end of the passage 411a opposite to the port 34, EMI leakage can be prevented through the rear cover portion 412. The plurality of elastic fingers 43 extend from the bending portion 42 away from the port 34 in the mating direction D, and one of the elastic fingers 43 is positioned at an outer surface of the guiding cover portion 411. The ground member 4 may be formed by stamping and bending a metal sheet, which is easy to manufacture, and the guiding cover portion 411 of the ground member 4 at the port 34 has a double-layer metal sheet thickness by the bending portion 42, is relatively strong in structure and is not easily deformed by collision. In the embodiment, the ground member 4 is composed of an upper member 4A and a lower member 4B, the upper member 4A is provided to the top wall 31 of the metal cage 3, the lower member 4B is substantially U-shaped and is provided to the two side walls 33 and the bottom wall 32 of the metal cage 3, so that the upper member 4A and the lower member 4B are provided to an outer circumference of the metal cage 3 and substantially surround the port 34. The upper member 4A and the lower member 4B may be fixed to the metal cage 3 by, for example, laser spot welding or riveting. Furthermore, the metal cage 3 has two positioning portions 37 protruding outwardly, the main body 41 further comprises two positioning holes 44 correspondingly receiving the two positioning portions 37 to enable the ground member 4 and the metal cage 3 to be positioned relative to each other when the ground member 4 the metal cage 3 are assembled with each other, thereby facilitating assembling. In a varied embodiment, the ground member 4 may also be a one-piece frame shape, or be a two-piece type that the upper member 4A is U-shaped and provided to the top wall 31 and the two side walls 33 of the metal cage 3 and the lower member 4B is provided to the bottom wall 32, and a position of the guiding cover portion 411 may be adjusted corresponding to a position of the keyway 36, and is not limited to the embodiment.

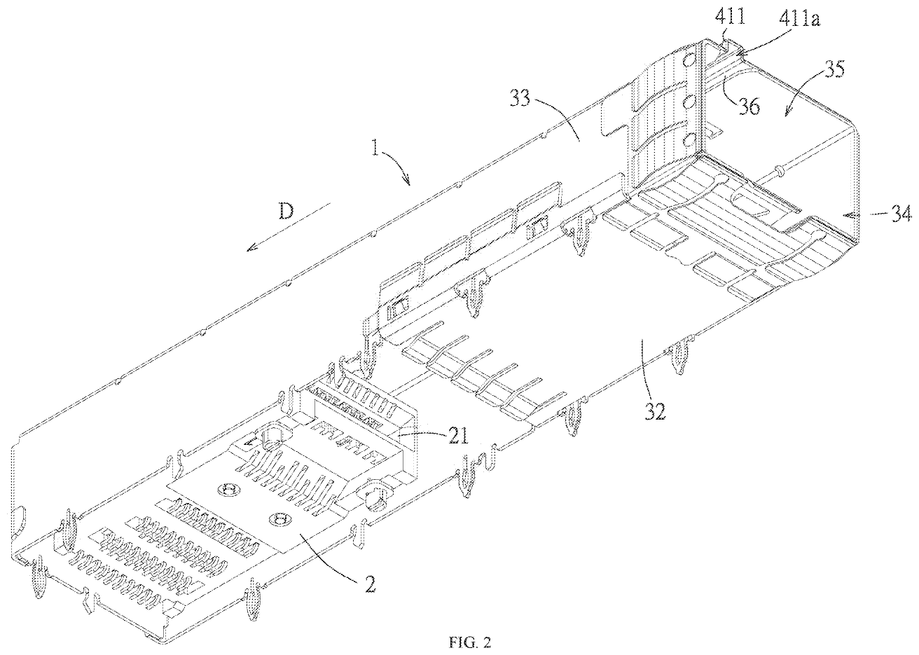

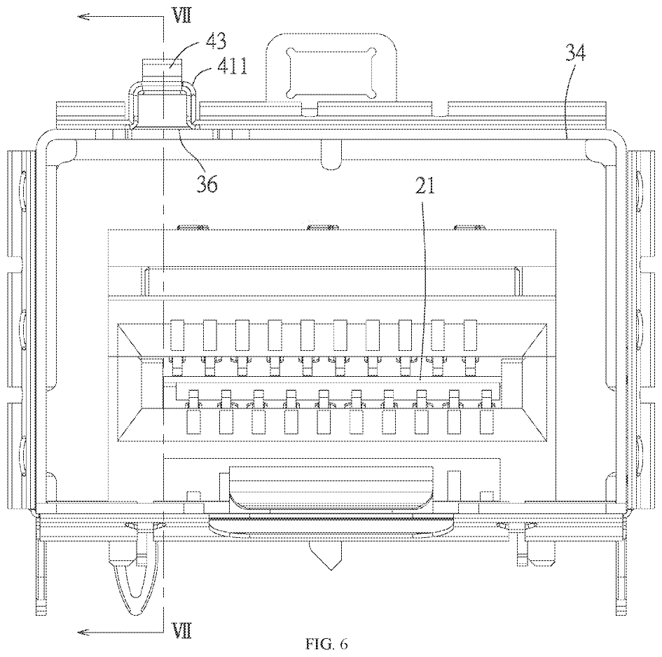

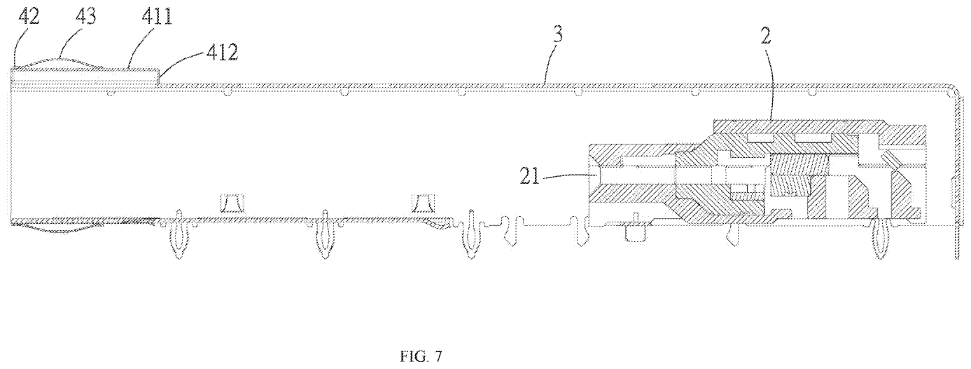

Referring to FIG. 2, FIG. 6 and FIG. 7, the electrical connector 2 is positioned in the accommodating space 35 and has a slot 21 which extends toward the port 34 along the mating direction D to allow the mating electrical connection device to mate therewith so as to form an electrical connection.

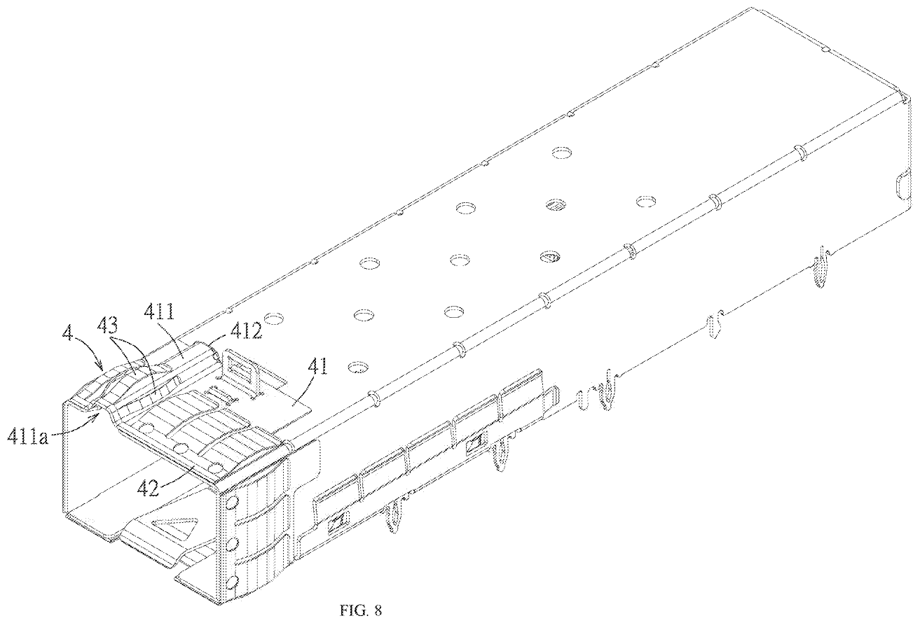

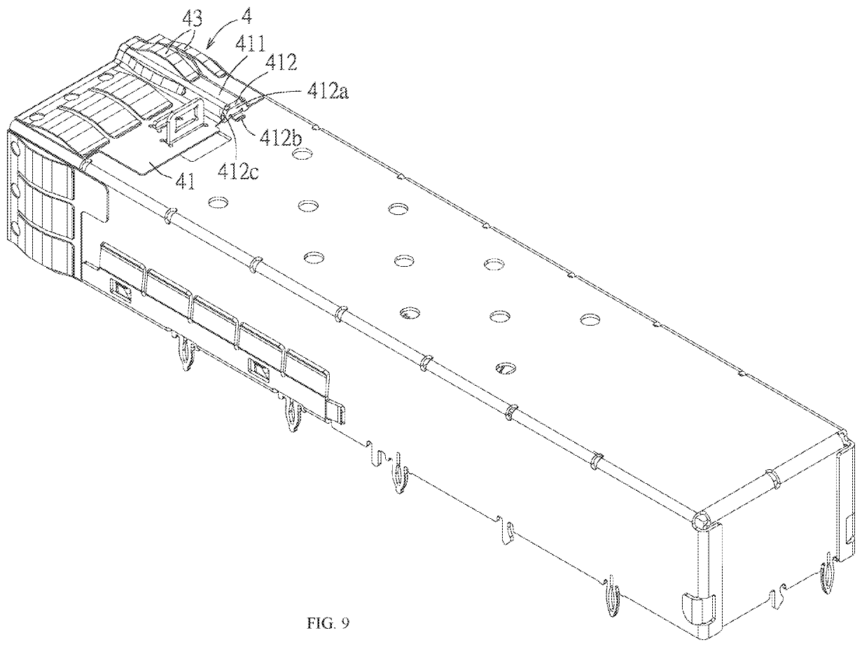

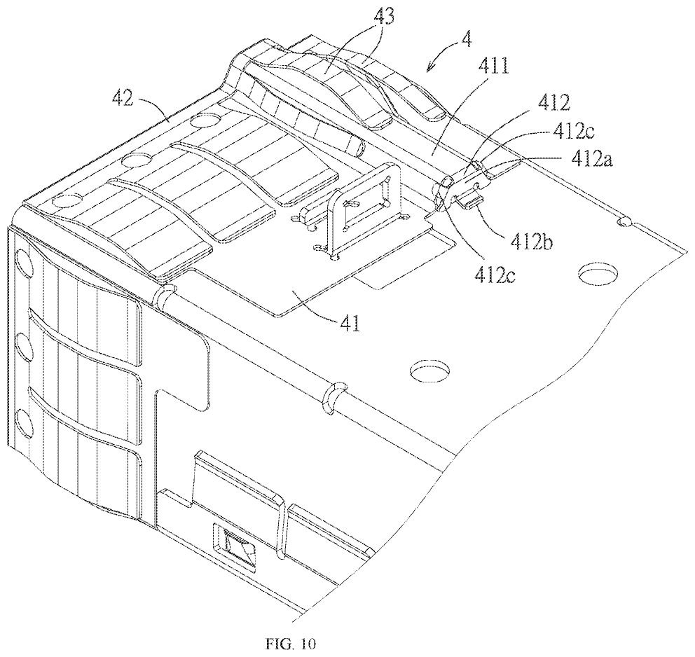

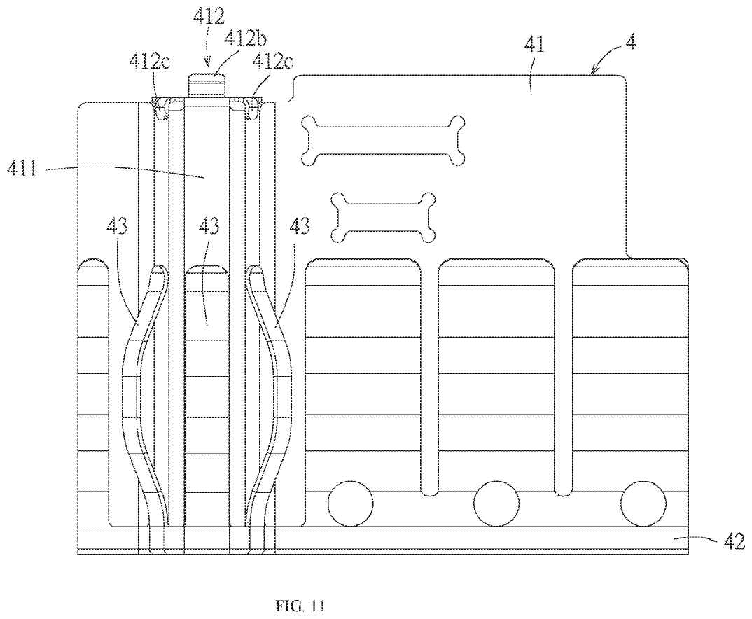

Referring to FIG. 8 to FIG. 11, a second embodiment of the electrical connection device of the present disclosure is substantially the same as the first embodiment, but in the second embodiment, there are three elastic fingers 43 to be positioned on the outer surface of the guiding cover portion 411, and the rear cover portion 412 has a cover segment 412a which covers the passage 411a, a bottom contact segment 412b which bends from the cover segment 412a, extends and contacts the metal cage 3 and two side contact segments 412c which bends from the cover segment 412a, extends and contacts the guiding cover portion 411. In the second embodiment, by the bottom contact segment 412b and the side contact segments 412c, effect of preventing EMI leakage is better than the first embodiment.

In conclusion, the ground member 4 may be formed by stamping and bending a metal sheet, which is easy to manufacture, and the guiding cover portion 411 of the ground member 4 at the port 34 has a double-layer metal sheet thickness by the bending portion 42, is relatively strong in structure and is not easily deformed by collision.

However, the above description is only for the embodiments of the present disclosure, and the implementing scope of the present disclosure is not limited thereto, and all the simple equivalent changes and modifications according to the scope of the claims and the specification of the present disclosure are still fallen within the scope of the present disclosure.

What is claimed is:

1. A shield cage assembly, comprising:
a metal cage which defines a port and an accommodating space extending from the port along a mating direction, and the metal cage having a keyway which extends from the port along the mating direction; and
a ground member which is provided to an outer surface of the metal cage adjacent to the port, and the ground member having a main body which is connected with the metal cage, a bending portion which bends back from an edge of the main body, extends and is adjacent to the port, and a plurality of elastic fingers which extend from the bending portion, the main body having a guiding cover portion which bulges, the guiding cover portion correspondingly covering the keyway and defining a passage which is communicated with the keyway.

2. The shield cage assembly of claim 1, wherein the plurality of elastic fingers extend from the bending portion away from the port.

3. The shield cage assembly of claim 2, wherein at least one of the elastic fingers is positioned at an outer surface of the guiding cover portion.

4. The shield cage assembly of claim 1, wherein the main body further has a rear cover portion which connects the guiding cover portion and covers an end of the passage opposite to the port.

5. The shield cage assembly of claim 4, wherein the rear cover portion has a cover segment which covers the passage and a bottom contact segment which bends from the cover segment, extends and contacts the metal cage.

6. The shield cage assembly of claim 5, wherein the rear cover portion further has at least one side contact segment which bends from the cover segment, extends and contacts the guiding cover portion.

7. The shield cage assembly of claim 1, wherein the metal cage has at least one positioning portion protruding outwardly, the main body further has at least one positioning hole correspondingly receiving the at least one positioning portion.

8. An electrical connection device, comprising:
a shield cage assembly, comprising:
a metal cage which defines a port and an accommodating space extending from the port along a mating direction, and the metal cage having a keyway which extends from the port along the mating direction; and
a ground member which is provided to an outer surface of the metal cage adjacent to the port, and the ground member having a main body which is connected with the metal cage, a bending portion which bends back from an edge of the main body, extends and is adjacent to the port, and a plurality of elastic fingers which extend from the bending portion, the main body having a guiding cover portion which bulges, the guiding cover portion correspondingly covering the keyway and defining a passage which is communicated with the keyway; and
an electrical connector which is positioned in the accommodating space and comprises a slot, the slot extending toward the port along the mating direction.

9. The electrical connection device of claim 8, wherein the plurality of elastic fingers extend from the bending portion away from the port.

10. The electrical connection device of claim 9, wherein at least one of the elastic fingers is positioned at an outer surface of the guiding cover portion.

11. The electrical connection device of claim 8, wherein the main body further has a rear cover portion which connects the guiding cover portion and covers an end of the passage opposite to the port.

12. The electrical connection device of claim 11, wherein the rear cover portion has a cover segment which covers the passage and a bottom contact segment which bends from the cover segment, extends and contacts the metal cage.

13. The electrical connection device of claim 12, wherein the rear cover portion further has at least one side contact segment which bends from the cover segment, extends and contacts the guiding cover portion.

14. The electrical connection device of claim 8, wherein the metal cage has at least one positioning portion protruding outwardly, the main body further has at least one positioning hole correspondingly receiving the at least one positioning portion.
